(19) United States
(12) Patent Application Publication
(10) Pub. No.: US 2018/0270717 A1
(43) Pub. Date: Sep. 20, 2018

(54) RADIO BASE STATION, AND USER EQUIPMENT

(71) Applicant: NTT DOCOMO, INC., Tokyo (JP)

(72) Inventors: Yuichi Kakishima, Tokyo (JP); Hiroki Harada, Tokyo (JP); Satoshi Nagata, Tokyo (JP)

(73) Assignee: NTT DOCOMO, INC., Tokyo (JP)

(21) Appl. No.: 15/762,169

(22) PCT Filed: Sep. 23, 2016
(86) PCT No.: PCT/US16/53378

§ 371 Date: Mar. 22, 2018

Related U.S. Application Data
(60) Provisional application No. 62/232,058, filed on Sep. 24, 2015.

(51) Int. Cl. H04W 36/00; H04B 7/06; H04W 36/30; H04B 17/24; H04B 17/309; H04W 24/10

(52) U.S. Cl. CPC H04W 36/0083; H04B 7/0617; H04W 24/10; H04B 17/24; H04B 17/309; H04W 36/30

(57) ABSTRACT

An embodiment of a radio base station is provided that comprises antennas at least one dimensionally arranged, a signal generation unit that generates a reference signal for channel measurement, a control unit that controls transmission of the reference signal in accordance with configurations using part or all of the antennas, the configurations including all or any of a horizontal relation, a vertical relation, and a cross-polarized relation, a handover control unit that controls a handover when a measurement report is received from a user terminal, a control signal generation unit that generates a control signal based on an instruction from the handover control unit, and a transmission unit that transmits the reference signal in accordance with the configurations based on output from the control unit.

### CROSS REFERENCE TO RELATED APPLICATIONS

This application claims priority to U.S. provisional Patent Application Ser. No. 62/232,058 filed on Sep. 24, 2015, entitled “RADIO BASE STATION, AND USER EQUPMENT”, the entire contents of which are incorporated herein by reference.

### FIELD OF THE INVENTION

The present disclosure relates to a radio communication technology, and particularly relates to a radio base station, user equipment, and a radio communication system for a three-dimensional multiple input multiple output (3D-MIMO) technique.

### BACKGROUND

The LTE standard specifications of the 3GPP (Third Generation Partnership Project) (hereinafter referred to as the “standard specifications”), and in particular, Releases 8 to 12 describe a technology for horizontal beamforming with multiple antenna elements in a base station arranged side by side in a transverse direction.

In Release 13 of the standard specifications, studies are in progress related to three-dimensional MIMO (3D-MIMO) in which a base station is equipped with multiple antenna elements two-dimensionally arranged. Such an arrangement can be used to form 3D beam(s), i.e., beam(s) that may be shaped/controlled in vertical and horizontal domain. The formation of a vertical beam (in an elevation angle direction) and a horizontal beam (in an azimuth angle direction) raises expectations for improvement of system characteristics.

In Release 12 of the standard specifications or earlier releases, closed loop precoding is implemented through feedback of channel state information (CSI) in the horizontal direction and CSI of cross-polarized elements, which is provided to a MIMO base station. In order to keep CSI feedback overhead small, a codebook in which multiple precoding matrices (linear filters) are written, is shared in advance between a base station apparatus and user equipment. The user equipment selects a desired precoding matrix from the codebook, and notifies the base station apparatus of the selected matrix number together with CQI. Then, the base station apparatus performs precoding on transmission data based on the feedback information, and performs MIMO transmission of the precoded transmission data.

Here, if there is a neighboring cell whose reception environment is better than that of a cell to which a terminal is currently connected (serving cell, hereinafter referred also to as a current cell), a handover (also abbreviated to HO below) technique is used by which the cell to which the terminal is connected is switched from the current cell to a different cell, e.g., a neighboring cell.

The terminal measures a reference signal receive power (RSRP) by using a cell reference signal (cell-specific reference signal: CRS or CSI-RS), and derives a received quality of physical downlink shared channel (PDSCH) of a handover target cell based on the RSRP.

FIG. 6 is a diagram illustrating a CRS-based handover. Here, it is assumed that UE 151 can perform radio communications with base stations eNB A and eNB B. In this case, it is also assumed to be better for UE 151 to connect to base station eNB A by applying beam a1 of eNB A. However, if UE 151 makes conventional CRS-based cell selection, UE 151 may possibly connect to eNB B because UE 151 does not consider 3D beamforming in 3D-MIMO. As described above, there is a case in which the conventional CRS-based cell selection fails in appropriate cell selection even with the aforementioned 3D beamforming in 3D-MIMO of Release 13 taken into consideration. A similar failure may occur in a condition in which the CSI-RS-based cell selection in Release 12 of the standard specifications is taken into consideration.

In connection with the Background description, attention is drawn to the following documents:

TS36.214 (Sec.5.1.20) “3GPP TS 36.214 Evolved Universal Terrestrial Radio Access (E-UTRA); Physical layer,; Measurements”: Definition of CSI-RSRP,
TS36.331 (Sec.5.5.4) “3GPP TS 36.331 Evolved Universal Terrestrial Radio Access (E-UTRA); Radio Resource Control (RRC); Protocol specification”: Measurement report triggering
Stefania, et al., LTE—The UMTS Long Term Evolution From theory to practice (Sec.3.2,5.2): Measurement report triggering

The entire contents of the three records above, particularly with regard to the definition of CSI-RSRP and the details of measurement report triggering are incorporated by reference herein in their entireties.

### SUMMARY

One or more embodiments of user equipment may comprise a reception unit that receives at least one downlink reference signal transmitted from a serving cell, a measurement unit that measures quality of the downlink reference signal from the serving cell, a determination unit that determines if a measurement report is necessary to the serving cell based on the measurement, and a transmission unit that generates the measurement report, and transmit the measurement report to the serving cell if the determination unit determines that the measurement report is necessary.

One or more embodiments of a radio base station may comprise antennas at least one dimensionally arranged, a signal generation unit that generates a reference signal for channel measurement, a control unit that controls transmission of the reference signal in accordance with configurations using part or all of the antennas, the configurations including all or any of a horizontal relation, a vertical relation, and a cross-polarized relation, a handover control unit that controls a handover when a measurement report is received from a user terminal, a control signal generation unit that generates a control signal based on an instruction from the handover control unit, and a transmission unit that transmits the reference signal in accordance with the configurations based on output from the control unit.

### BRIEF DESCRIPTION OF DRAWINGS

FIG. 1 is a schematic diagram illustrating a radio communication system of one or more embodiments;

FIG. 2 is a block diagram illustrating user equipment UE of one or more embodiments;

FIG. 3 is a flowchart illustrating an operation of measurement report triggering (MRT) controller 129 in one or more embodiments;

FIG. 4 is a block diagram illustrating one or more embodiments of a radio base station;

FIG. 5 is a sequence diagram illustrating a handover in accordance with one or more embodiments; and

FIG. 6 is a schematic diagram illustrating RS transmission for 3D MIMO technologies.

### DETAILED DESCRIPTION

Embodiments are explained with reference to drawings. In the respective drawings referenced herein, the same constituents are designated by the same reference numerals and duplicate explanation concerning the same constituents is basically omitted. All of the drawings are provided to illustrate the respective examples only. No dimensional proportions in the drawings shall impose a restriction on one or more embodiments. For this reason, specific dimensions and the like should be interpreted with the following descriptions taken into consideration. In addition, the drawings may include parts whose dimensional relationship and ratios are different from one drawing to another.

### (Beamforming Technologies)

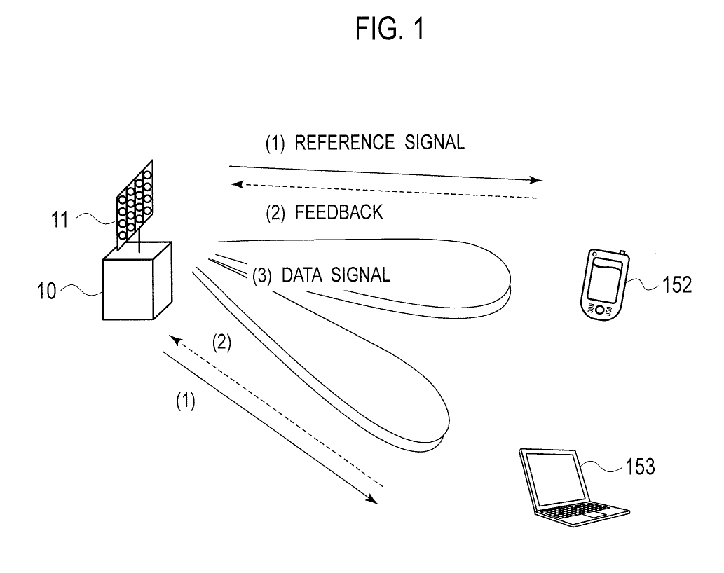

FIG. 1 is a schematic diagram illustrating a radio communication system of one or more embodiments. Radio communication system 1 includes radio base station 10, user equipment 152, and user equipment 153. The illustrated embodiment or embodiments employs multi-user MIMO (MU-MIMO) in which transmission signals to user equipment 152 and user equipment 153 from radio base station 10 are spatially multiplexed. However, the invention is not limited to MU-MIMO system.

Radio base station 10 includes antenna array 11 in which multiple antennas are arranged two-dimensionally in vertical and horizontal directions. Radio base station 10 uses part or all of the antennas included in antenna array 11 to transmit reference signals (RSs) to be used by user equipment 152, 153 to estimate channel information (arrow (1)). The reference signal is not particularly limited. Besides CSI-RS, CRS (Cell-specific Reference Signal), DM-RS (Demodulation Reference Signal), DRS (Discovery Reference Signal), any existing/new RS or other physical channels and/or signals may be used. The described embodiment or embodiments employ two-dimensional antennas, however one or more embodiments may employ one-dimensional, or three-dimensional antennas.

Each user equipment 152, 153 feeds back channel state information (CSI) estimated from the received reference signals to radio base station 10 (arrow (2)).

Radio base station 10 generates transmission precoding weights for suppressing mutual interference between user equipment 152 and user equipment 153, performs transmission beamforming for data signals and reference signals for channel estimation, which are addressed to each user equipment 152, 153, and transmits the data signals (arrow (3)).

Radio base station 10 may calculate a precoding vector for beamforming based on the CSI fed back from each user equipment 152, 153, and may notify each user equipment 152, 153 of the calculated precoding vector. Alternatively or in addition, each user equipment 152, 153 may calculate a precoding vector from the estimated channel information (channel matrix), and may feed back the precoding vector to radio base station 10. Alternatively, radio base station 10 and each user equipment 152, 153 may hold a common codebook (precoding matrix group), and each user equipment 152, 153 may select a desired precoding vector based on the estimated channel matrix.

The contents of Japanese Patent Application Publication No. JP 2014-204305 and International Publication No. WO 2014/162805, particularly 3D-MIMO technique details are incorporated herein by reference in their entireties.

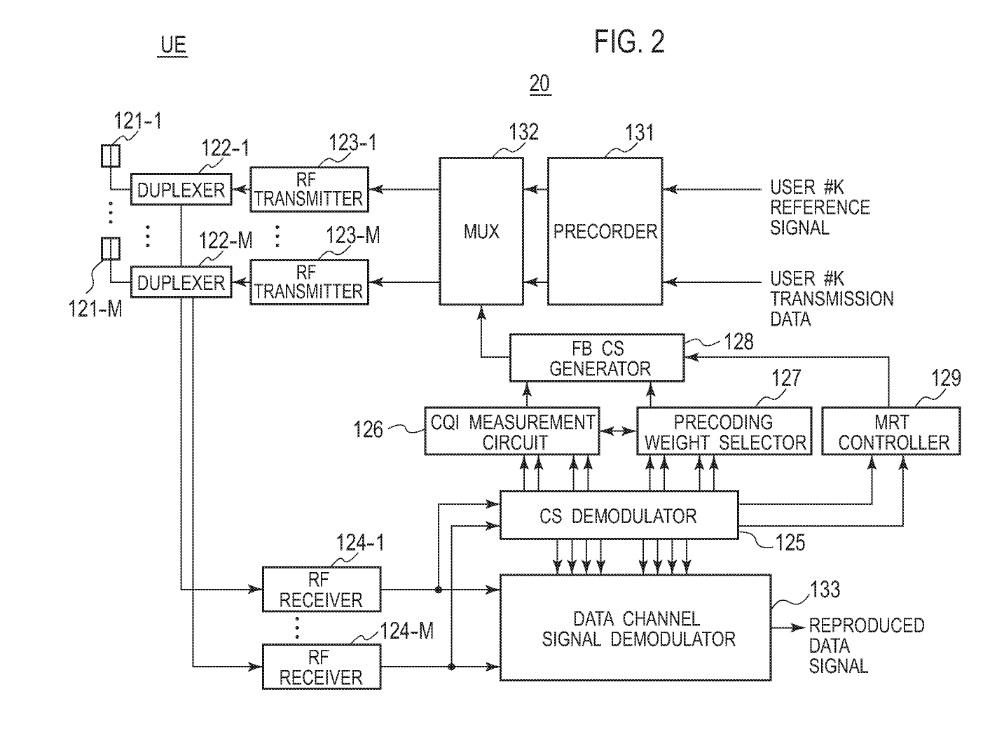

FIG. 2 is a block diagram illustrating user equipment UE of one or more embodiments. The user equipment receives reference signals from radio base station 10 via multiple antennas 121-1 to 121-M, multiple duplexers 122-1 to 122-M, and multiple RF receiver circuits 124-1 to 124-M. Control signal demodulator 125 demodulates various control signals received from RF receiver circuits 124-1 to 124-M. Here, control signal demodulator 125 performs channel estimation based on the reference signals present among the demodulated various control signals. Precoding weight selector 127 selects a precoding weight based on the channel estimation value. Channel quality measurement circuit 126 (channel quality measurement unit) measures a channel quality based on the received reference signals.

The measurement result of the channel quality and the selection result of the precoding weight are inputted to feedback control signal generator 128. Feedback control signal generator 128 generates a feedback signal to be sent to a radio base station (not illustrated). The feedback signal may include precoding matrix W containing horizontal channel information, vertical channel information, and cross-polarized channel information. The feedback signal may include matrix W obtained by extending an existing 2D-MIMO codebook in the vertical direction, or may include only the existing 2D-MIMO codebook. The feedback signal may include other CSI such as beam index (BI) RI and CQI.

User reference signals and user data signals are precoded by precoding unit 131, and are inputted to multiplexer (MUX) 132. Multiplexer 132 multiplexes the user reference signals, the user data signals, and a feedback signal with each other. The multiplexed signals are transmitted via RF transmitter circuits 123-1 to 123-M and duplexers 122-1 to 122-M from antennas 121-1 to 121-M.

Here, MRT controller 129 receives a control signal demodulated by control signal demodulator 125, and generates measurement report (MR) if a certain condition is satisfied. Based on the generated measurement report, feedback control signal generator 128 generates a feedback signal to be sent to the radio base station (not illustrated).

### (Measurement Report of UE)

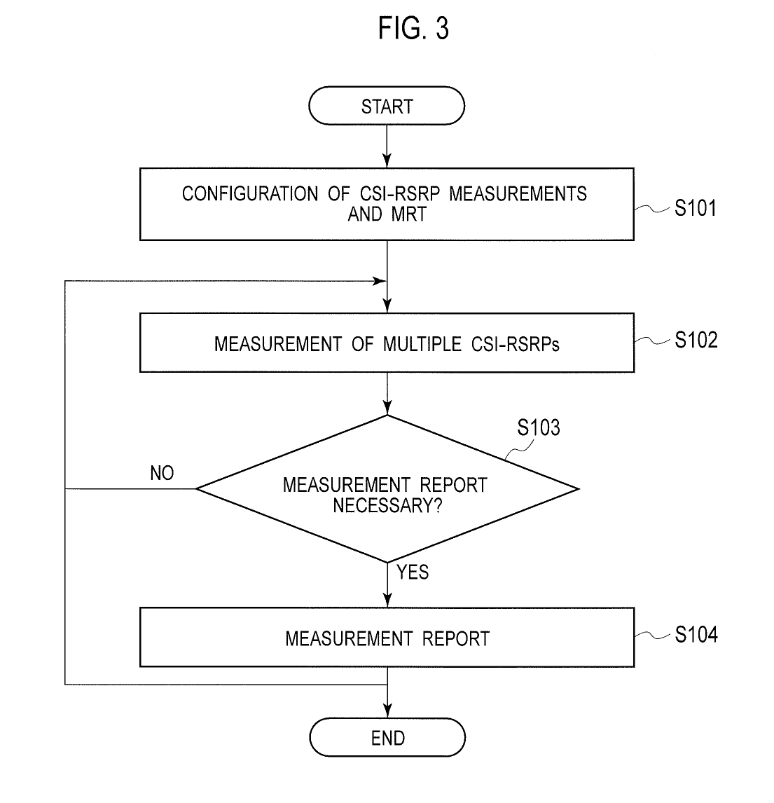

FIG. 3 is a flowchart illustrating an operation of MRT controller 129 in one or more embodiments. Firstly, MRT controller 129 configures channel state information-reference signal received power (CSI-RSRP) measurements and measurement report triggering (MRT) (step S101). The configuration of information includes configuration of a range and a procedure of the CSI-RSRP measurements. The configuration of the information may be omitted if an existing configuration is used. Alternatively or additionally, the configuration information maybe received from an eNB. The MRT controller 129 may measure multiple CSI-RSRPs in accordance with the conditions configured in step S101 (step S102). The measurement by the MRT controller 129 is performed on the relevant signals from among the control signals demodulated by control signal demodulator 125 in FIG. 2. The MRT controller 129 determines whether or not to make a measurement report (MR) based on the CSI-RSRPs measured in step S102 (step S103). In a condition in which the MRT controller 129 determines to make an MR, the MRT controller 129 generates the MR (step S104). Meanwhile, in a condition in which the MRT controller 129 determines not to make an MR, the operation returns to step S102.

### (Detailed Description of Step S103)

Next, description is provided for step S103 which involves determining whether or not a measurement report is necessary. In one or more embodiments, UE determines that a measurement report to eNB is necessary if any of the following conditions is satisfied. In this way, UE makes an MR to an eNB. A source eNode B (S-eNB) having received the MR makes an HO request to a target eNB (T-eNB) to which UE will perform handover.

In one or more embodiments, a determination that the MR is necessary is made in any of the following cases. The MR may be determined as necessary if any one of the following conditions is satisfied, or if any two or more of the following conditions are satisfied.

### CRS (Intra-EUTRAN HO)

Event A1: If conditions of a serving cell become better than a threshold;

Event A2: If conditions of the serving cell become worse than a threshold;

Event A3: If conditions of a neighboring cell become better than the serving cell;

Event A4: If conditions of the neighboring cell become worse than a threshold; and

Event A5: If conditions of the serving cell become worse than a threshold (Thres1), and conditions of a neighboring cell becomes better than a threshold (Thres2).

### CRS (Inter-RAT HO)

Event B1: If conditions of an inter-RA neighboring cell become better than a threshold; and

Event B2: If conditions of a serving cell become worse than a threshold (Thres1) and the conditions of the inter-RAT neighboring cell becomes better than a threshold (Thres2).

### CSI-RS

Event C1: If conditions of the CSI-RS resource become better than a threshold; and

Event C2: If the offset parameter of the CSI-RS resource becomes better than the offset parameter of the reference CSI-RS resource.

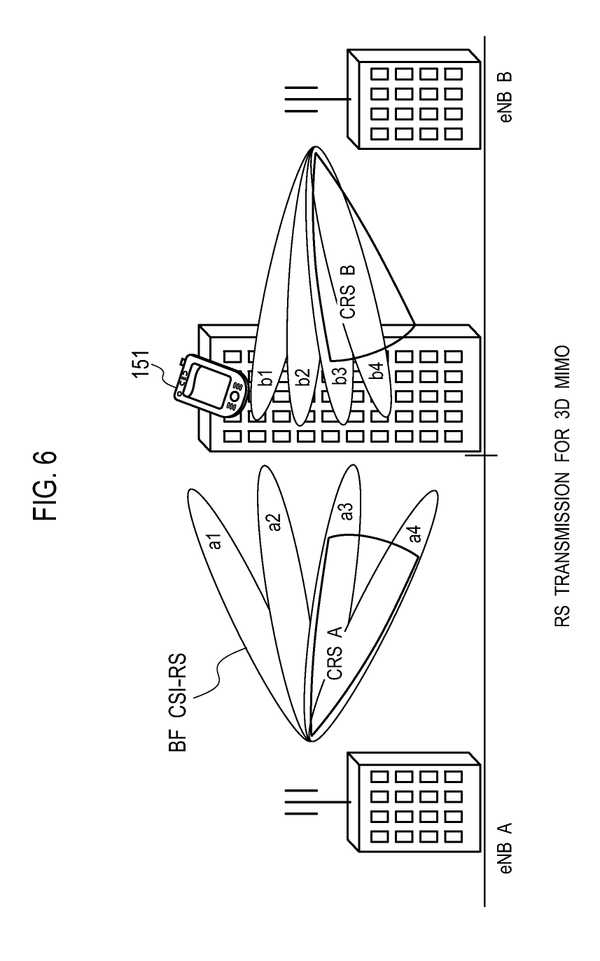

Next, description is provided for a method of making an MR for each beam group or reference signal group. For example, an MR for a beam group may be made on a cell-ID basis. Here, a beam group is explained. In FIG. 6, base station eNB A emits reference signals or beams a1, a2, a3, and a4. In addition, base station eNB B emits reference signals or beams b1, b2, b3, and b4. In this case, a group of reference signals or beams a1, a2, a3, and a4 may be called a beam group or reference signal group. In addition, a group of reference signals or beams b1, b2, b3, and b4 may also be called a beam group. MRs different between beam groups may be generated and signaled. In the following description, it will be understood that the term “beams” may also refer more generally to reference signals.

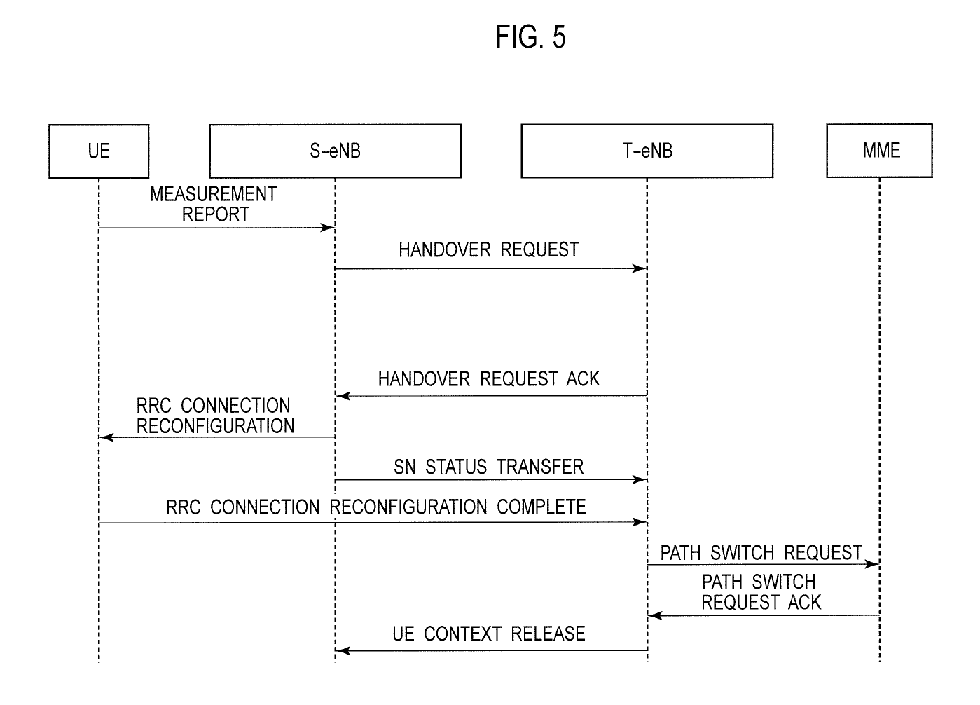

1) For the foregoing HO related events A1 to A5, B2, C1, and C2, the determination of the condition is made based on the greatest or most favorable condition values in the beam groups. For example, in a condition in which al has the highest RSRP in the group A and b1 has the highest RSRP in the group B in FIG. 5, the determination for the MRT is made based on the RSRPs of a1 and b1;
2) For the foregoing HO related events A1 to A5, B2, C1, and C2, the determination of the condition is made based on the average condition values in the beam groups. The determination for the MRT is made based on the average RSRP of the group A and the average RSRP of the group B;
3) For the foregoing HO related events A1 to A5, B2, C1, and C2, the determination of the condition is made based on Best-M values in the beam groups. The Best-M value may be defined as an average value of the best M values or may be the M-th best value. A numerical value of M may be signaled from an eNB, or may be implicitly derived based on the number of measurements configured in step S101 in FIG. 3.

In an alternative or additional embodiment or embodiments of the foregoing example, any of the calculation methods of Ms, Mp, Mn, Mcr, and Mref defined in Sec. 5.5.4.2 to 10 in TS36.331 may be specified. For example, event A1 is specified as Ms-Hys>Thresh and the like. In this case, Ms may be specified for use to obtain the greatest value of the beam group.

In addition, the MR may include switching information indicating switching from a1 to a2 in regard to a determination of a precoder, though a1 and a2 are beams emitted from the same eNB A. In other words, intra-cell optimal beam switching may be regarded as an MRT, and the MR may be made in response to intra-cell optimal beam switching. For the MRT in this case, triggering determination may be made on a beam-by-beam basis.

### (Detailed Description of Step S104)

UE makes the MR if UE determines to make the MR in the above step S103. From the viewpoint of the nature of a measurement report, it is desirable that the measurement result should be averaged in terms of time and frequency. In other words, in order to avoid ping-pong handover, the measurement report is desired to be free from instantaneous fluctuations. To this end, the following configuration is preferable in the case of making an MR:

1) A method of applying L3 filtering to measurement results of beamformed CSI-RSs (CRSS); and

2) A method of applying time-to-trigger and hysteresis to a measurement report of beamformed CSI-RSs (CRSS).

Here, the L3 filtering is time averaging processing using a forgetting factor which is used by a mobile terminal to remove an influence of fast fading:

Fₙ=(1−α)Fₙ₋₁+αMₙ,

Mn: Measurement result, and

Fn: Updated filtered measurement result.

Then, time-to-trigger is a technique of performing cell switching with a temporal margin provided after a threshold for cell switching is exceeded.

Meanwhile, hysteresis is a margin to be used by the terminal in the case of transmitting an HO request. For example, hysteresis Hys is provided as a margin to the entering condition of Event A3. With this hysteresis, ping-pong at a cell boundary can be avoided:

Mₙ+O_{fn}+O_{cn}−H_{ys}>Mₛ+O_{fs}+O_{cs}+O_{ff},

Mₙ, Mₛ: Measurement result;

O_{fn}, O_{fs}: Frequency specific offset;

O_{cn}, O_{cs}: Cell specific offset; and

O_{ff}: Offset parameter for this event.

Since a beamformed CSI-RS (CRS) has a narrow beam width, an instantaneous fluctuation of the RSRP value may possibly vary (increase). For example, there is a possibility that appropriate handover-related parameters (a hysteresis, a time forgetting factor (L3 filtering value), and a time-to-trigger value) may vary between UE adopting 3D MIMO and UE not adopting 3D MIMO. In the case of inter-cell beam switching, in particular, the foregoing parameters may be configured dedicatedly. The following may be applied, for example:

1) Handover-related parameters are configured for each UE (the virtual hysteresis and others); and

2) eNB determines multiple candidates for each handover-related parameter in a cell-specific manner, and notifies each UE of the determined candidates. For example, the former is notified via broadcast information, and the latter is notified via RRC.

On the other hand, the same calculation methods as those in the existing RSRP measurement method may be employed. In this case, the parameters used in the existing RSRP measurement method are also used as the aforementioned RSRP measurement parameters. This enables reduction in signaling.

### (Reported Value)

Information contained in an MR may be in the following forms:

1) Reporting a cell ID, for instance, as in a form to report “a” in the example of FIG. 6.

2) Reporting an RS index (such as a beam number or reference signal number or ID, for instance, as in a form to report “1” in the example of FIG. 6.)

3) Reporting a cell ID and a beam number, for instance, as in a form to report “a1” in the example of FIG. 6. In this case, a flag may also be used to identify which of the cell ID and the beam number the reported value indicates. Alternatively, a value obtained by joining the above two values, namely, the cell ID and the beam number may be notified as a single index.

4) Reporting reception quality (e.g. RSRP), for instance, as in a form to report the highest RSRP. In this case, the highest RSRP for each cell may be reported. The highest M RSRPs may be reported like Best-M. An average value of the highest M RSRPs may be reported. Otherwise, an M-th best RSRP may be reported. Here, all the M RSRPs are not necessarily needed. For example, the number of RSRPs to be reported may be set smaller than M. For instance, Best-M cell-beam numbers and the Best-1 (single) RSRP may be reported. Alternatively, all the RSRPs may be reported.

5) Reporting a combination of the aforementioned candidates. For example, the cell ID, beam number (or reference signal number or ID) and RSRP may be reported in combination.

6) Reporting reception qualities (e.g. RSRPs) by using differential value relative to anchor value in order to reduce feedback overhead. An anchor may be reported as Non-precoded CRS and the other RSRPs may be reported by using differences. The anchor may be an average value of or the highest value (or lowest value) among the RSRPs to be reported.

The reported value should not be limited to a single value. The reported value may include a plurality of values. For example, a feedback signal from UE may include three cell IDs of the three cells having the highest reception quality.

Here, the aforementioned reporting of the cell-beam numbers and/or the RSRP values may be made by using an existing measurement report mechanism. For example, the above beam number may be added to the existing measurement report, and thus be notified. Likewise, the above reporting may be notified as a CSI feedback. For example, some or all of the above cell-beam numbers and RSRP values may be notified as periodic or aperiodic CSI reports. Similarly, the above reporting may be notified as a new report other than the measurement report or the CSI report.

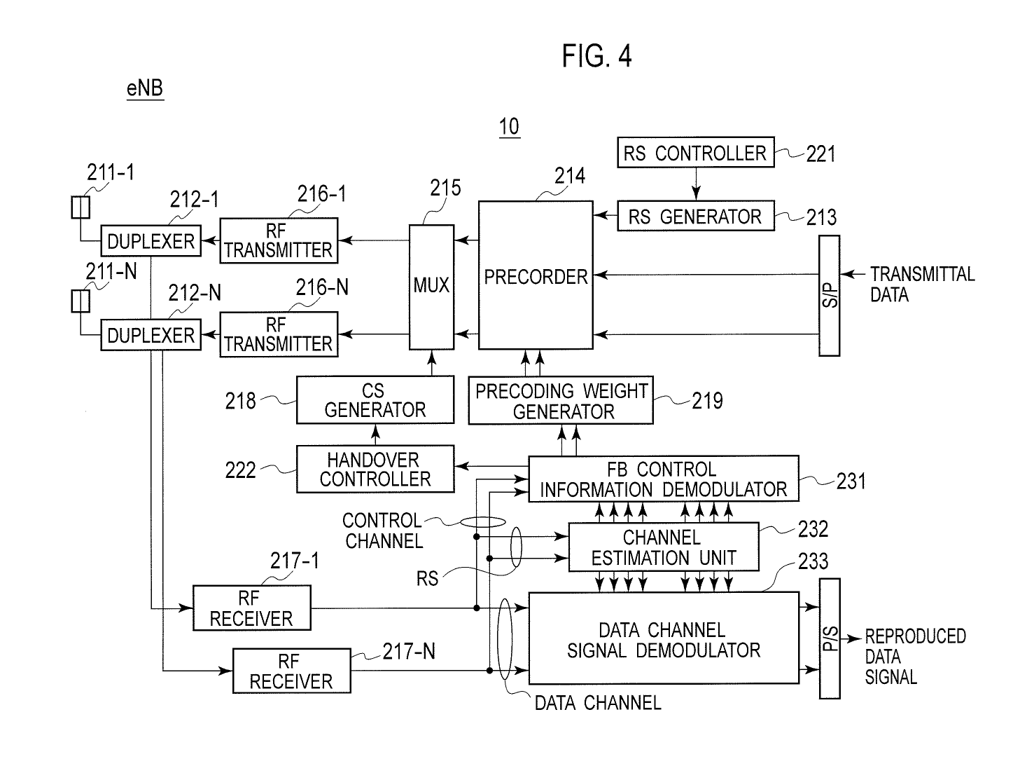

FIG. 4 is a block diagram illustrating an embodiment of a radio base station. Radio base station 10 includes multiple antennas 211-1 to 211-N two-dimensionally arranged, as well as radio frequency (RF) transmitter circuits 216-1 to 216-N and radio frequency (RF) receiver circuits 217-1 to 217-N corresponding to the number of the antennas.

Reference signal generator 213 generates a reference signal for channel measurement. Precoding weight generator 219 generates precoding weights based on feedback information received via antennas 211-1 to 211-N and RF receiver circuits 217-1 to 217-N. Precoding unit 214 precodes the reference signal and data signal by using the generated precoding weights. It will be understood by one of skill in the art that the data signal inputted to precoding unit 214 may have already been processed through serial/parallel conversion, channel coding, modulation, and the like, the illustration and description of which is omitted.

Multiplexer (MUX) 215 multiplexes the precoded reference signals and data signals. RS configuration controller 218 controls setup and switching of transmission configurations (RS configurations) of reference signals to be used for channel estimation. RS configuration controller 218 controls mapping of multiple different RS configurations to resources. Alternatively, RS configuration controller 218 may control setup timings and override timings of the RS configurations. Under this control, the reference signals are multiplexed in sequences corresponding to the RS configuration used. The multiplexed signals are transmitted from antennas 211-1 to 211-N via RF transmitter circuits 216-1 to 216-N and duplexers 212-1 to 212-N.

A feedback signal from UE (not illustrated) is received via antennas 211-1 to 211-N, duplexers 212-1 to 212-N, and RF receiver circuits 217-1 to 217-N, and is demodulated by feedback control information demodulator 231. The demodulation result is provided to precoding weight generator 219, and precoding weight generator 219 generates the precoding weights according to the feedback information. Note that description is omitted herein for channel estimation based on reference signals for channel estimation (operation of channel estimator 232), demodulation of data signals (operation of data channel signal demodulator 233), and decoding of the data signals.

Here, RS Controller 221 controls reference signals for channel measurement. In one or more embodiments, RS Controller 221 controls BF CSI-RS or BF-CRS and gives an instruction indicating which reference signal to generate to reference signal generator 213. Reference signal generator 213 generates the reference signal based on the instruction from RS controller 221, and transmits the generated reference signal to precoding unit 214. Hereinafter, the control of the reference signal is explained.

First, description is provided for a case in which cell selection (beam selection) is made based on beamformed CSI-RS (BF CSI-RS). UE receives a CSI-RS contained in a Downlink reference signal from a base station. In this embodiment, UE receives a beamformed CSI-RS.

### (Number of BF CSI-RSs)

A case in which a single cell transmits a single BF CSI-RS involves a method of forming the BF CSI-RS such that BF CSI-RS covers multiple beams to be applied to data signals, for example. The following may also apply to a system or may be combined with a system in which a single cell transmits multiple BF CSI-RSs.

Alternatively, a case in which a single cell transmits multiple BF CSI-RSs involves a method of applying the same (or similar) beams as the multiple beams to be applied to data signals, for example. The number of beams applicable to data signals and the number of beams applied to BF CSI-RSs may be different from each other. For example, for the purpose of reducing RS overhead or doing the like, the number of beams of BF CSI-RSs of a handover target may be reduced. In this case in which a single cell transmits multiple BF CSI-RSs, the cell may transmit the number of BF CSI-RS to the target UE. For instance, the cell may transmit the number of BF CSI-RS as a RRC signal. Also the cell may transmit the number of BF CSI-RS as a result based on the decrypted signal of a synchronization signal (SS.) Alternatively, the cell transmits multiple BF CSI-RSs in the system information block (SIB) or/and the master information block (MIB.) Furthermore, the number of BF CSI-RS may be fixed value.

BF CSI-RSs of the same cell may be transmitted as group to UEs. Alternatively, a plurality of beams of the same cell may be grouped.

### (BF CSI-RS Multiplexing Method)

Next, a BF CSI-RS multiplexing method is explained. The multiplexing may be made by using the same resource elements (REs) as those of existing CSI-RSs in order to avoid collision with another physical channel or signal or to avoid impact on legacy UE, or instead may be made by using new resource elements.

The BF CSI-RS multiplexing method may use antenna ports (APs). This includes a method of applying different beams to different APs and measuring multiple RSRPs. For example, APs including not only AP 15 but also part or all of APs 16 to 22 may be used to measure multiple RSRPs. In addition, this includes a method of signaling APs where CSI-RSRPs are to be measured. In this case, signaling information may be in a bitmap format indicating each AP, or may be in a format indicating the number of APs targeted for the measurement. In addition, APs specified in the standard specifications of Release 13 or later releases may be used. In this case, a measurement of multiple RSRPs is performed by using part or all of given APs.

The BF CSI-RS multiplexing method may use time-division multiplexing (TDM). In this case, the method includes a method of applying different beams at different subframes, or different symbols, for example. In other words, information multiplexed by TDM may be signaled to UE. In this case, signaling information may contain any one or both of a time repetition cycle and a time offset.

The BF CSI-RS multiplexing method may use frequency-division multiplexing (FDM). In this case, the method includes a method of applying different beams at different resource blocks (RBs), for example. In other words, information multiplexed by FDM may be signaled to UE. In this case, signaling information may contain any one or both of a frequency repetition cycle and a frequency offset. Beams may be switched in units of sub-bands by using multiple consecutive frequency slots. For example, the size of a sub-band and the number of sub-bands may be signaled.

Here, the above signaling may be performed via an upper layer (e.g., of an exemplary layered protocol architecture as would be understood by one of ordinary skill in the art) to reduce signaling overhead. Alternatively, the signaling may be performed dynamically via a lower layer.

The multiplexing may be implemented by a combination of two or more of the aforementioned multiplexing methods using APs, TDM, and FDM.

In addition, a beamformed CSI-RS list which contains a single or multiple beamformed CSI-RSs for reception quality measurement (e.g., RSRP measurement) maybe sent. In this case, the list may be indexed on a cell-by-cell basis. In this list, UE may autonomously search for all or some of CSI-RS configurations defined in the specifications. The beamformed CSI-RS list may contain beamformed CSI-RSs of different cells. The beamformed CSI-RS list may contain a cell index therein. By using this, whether or not beam switching is accompanied by a handover can be judged. Moreover, the beamformed CSI-RS list may contain co-location information. In the case of beam selection from multiple cells, beamformed CSI-RSs are synchronized based on the co-location information. In another case, the beamformed CSI-RS list may contain only several highest CSI-RSs with averaging taken into account, for example. Alternatively, the beamformed CSI-RS list may contain only CSI-RSs exceeding a predetermined RSRP. This enables reduction in CSI overhead.

The CSI-RS for RSRP measurement may also be used for the purposes of CSI measurement, i.e., beam selection, calculation of RI/PMI/CQI, and the like. Alternatively, the CSI-RS may be used exclusively for RSRP measurement.

The CSI-RS measurement may also be used for the purpose of synchronization of UEs, which includes time synchronization and frequency synchronization.

The cell selection may be made based on the beamformed CSI-RS achieving the highest RSRP. For example, the cell determination may be made by considering several highest CSI-RSs with averaging taken into account. Alternatively, it is also possible to select a cell having the largest number of CSI-RSs exceeding a predetermined RSRP. The cell selection may be combined with the existing CRS-based cell selection. In this case, the cell selection may be made based on CRSs in a first stage and then be made based on beamformed CSI-RSs in a second stage. Alternatively, the cell selection may be made based on beamformed CSI-RSs in the first stage and then be made based on CRSs in the second stage.

Next, description is provided for a case in which cell selection (beam selection) is made based on Beamformed CRS (BF CRS).

### (Number of BF CRSs)

A case in which a single cell transmits a single BF CRS (the following also applies to a system combined with a system where a single cell transmits multiple BF CRSs) involves a method of forming the BF CRS such that BF CRS covers multiple beams to be applied to data signals, for example.

Alternatively, a case in which a single cell transmits multiple BF CRSs involves a method of applying the same (or similar) beams as the multiple beams to be applied to data signals, for example. The number of beams applicable to data signals and the number of beams applied to BF CRSs may be different from each other. For example, for the purpose of reducing RS overhead or doing the like, the number of beams of BF CRSs may be reduced.

### (BF CRS Multiplexing Method)

Next, a BF CRS multiplexing method is explained. The multiplexing may be made by using the same REs as those of existing CSI-RSs in order to avoid collision with another physical channel or signal or to avoid impact on legacy UE.

The BF CRS multiplexing method may use APs. For the exiting RSRP measurement, CRS AP0 or AP1 depending on UE implementation is applied. In another possible method, BF CRSs may be transmitted by using APs 1 to 3. This involves a method of signaling APs where RSRPs are to be measured. Different beams are applied to different APs, and multiple RSRPs are measured. Here, APs 2 and 3 have an insertion density which is half that of APs 0 and 1. For this reason, it is preferable to measure a single RSRP by using AP 2, 3. Note that the existing specifications only allow (1, 2, 4) as CRS AP. Thus, allowing AP (3) as CRS AP enables a reduction in RS overhead and a reduction in impact on legacy UE.

The BF CRS multiplexing method may use TDM. In this case, the method includes a method of applying different beams at different subframes, for example. In other words, information multiplexed by TDM may be signaled to UE. In this case, signaling information may contain any one or both of a time repetition cycle and a time offset.

The BF CRS multiplexing method may use FDM. In this case, the method includes a method of applying different beams at different RBs, for example. In other words, information multiplexed by FDM may be signaled to UE. In this case, signaling information may contain any one or both of a frequency repetition cycle and a frequency offset. Beams may be switched in units of sub-bands (by using multiple consecutive frequency slots). For example, the size of a sub-band and the number of sub-bands may be signaled.

Here, the above signaling may be performed via an upper layer to reduce signaling overhead. Alternatively, the signaling may be performed dynamically via a lower layer.

In addition, different beams may be applied to CRSs present at different RE locations within the same sub-frame.

Although the existing CRSs are multiplexed in all the sub-frames and at all the frequency locations, CRSs for RSRP measurement may be inserted at a reduced insertion density in some cases. In other words, CRSs may be multiplexed only at some of time or frequency resources.

The multiplexing may be implemented by a combination of two or more of the aforementioned multiplexing methods using APs, TDM, and FDM.

Next, handover controller 222 is described. Handover controller 222 receives feedback control information demodulated by feedback control information demodulator 231. Handover controller 222 controls a handover based on this control information, and gives an instruction to control signal generator 218. Control signal generator 218 generates a signal necessary for a handover sequence, and transmits the signal to MUX 215. Here, a case in which a handover is needed is a case in which switching to an optimal beam requires switching to another cell, and for instance is a case in which beam al is switched to beam bl in the example of FIG. 6. On the other hand, a case in which a handover is not needed is a case in which switching to an optimal beam does not require switching to another cell, and for instance is a case in which beam al is switched to beam a2 in the example of FIG. 6.

### (Handover Sequence)

In a mobile communication system provided with multiple cells, UE (User Equipment) is configured to continue communications by cell switching when moving from one cell to another cell. Such cell switching involves a cell reselection and a handover. When the received power or received quality of a signal from a neighboring cell becomes higher than the received power or received quality of a signal from the serving cell, UE performs a cell reselection or a handover to the neighboring cell.

FIG. 5 is a sequence diagram explaining a handover. First, UE transmits an MR to handover a source eNB (S-eNB). The S-eNB having received the MR transmits an HO request to handover to a target eNB (T-eNB). The T-eNB having received the HO request performs processing such as reservation of resources for the UE for which the handover is expected to be performed, reservation of resources for data transfer, and start of new allocation of a MAC scheduler of SRB1, and the like. Thereafter, upon completion of the above processing, the T-eNB returns Handover Request ACK to the S-eNB. The S-eNB having received Handover Request ACK transmits a signal of RRC Connection Reconfiguration to the UE. Then, by using resources for C-plane, the S-eNB notifies handover target radio base station the T-eNB of a transfer status of discontinuous uplink data to handover target radio base station the T-eNB (e.g., by using a SN Status Transfer signal). Upon completion of preparation for RRC connection reconfiguration, UE transmits an RRC connection Reconfiguration complete signal to the T-eNB. The T-eNB transmits a Path Switch request to a mobility management entity (MME) as the cell to which UE is connected has been changed, and MME returns ACK to the T-eNB. Upon completion of these, the T-eNB transmits a context release signal (UE context Release signal) to the S-eNB.

The cell reselection is processing in which the UE in an

Idle state transitions from the serving cell to a neighboring cell. The handover is processing in which UE performing communications transitions from one cell, such as the serving cell to another cell, such as a neighboring cell.

3D MIMO, which is discussed to be standardized in Release 13, requires a cell selection with the form of a 3D beam taken into account.

According to the foregoing embodiment or embodiments, it is possible to carry out a cell selection based on beamformed CSI-RS, which is an effective technique for cell selection in 3D MIMO. In addition, a measurement report trigger used as a cell switching request signal is extended for beamformed CSI-RS. Thus, an appropriate cell selection using beamformed CSI-RSs can be carried out.

According to the foregoing embodiment or embodiments, it is possible to carry out a handover for 3D MIMO by using a virtualized CRS or a beamformed CSI-RS. In addition, in one or more embodiments, the reference signal transmission method and handover trigger events for 3D MIMO can be specified. It should be noted that one or more embodiments can be applied to both the handover (cell switching in an ECM-CONNECTED state) and the cell reselection (cell switching in an RRC_IDLE state).

The reference signal is not particularly limited. Besides CSI-RS, CRS (Cell-specific Reference Signal), DM-RS (Demodulation Reference Signal), and any RS newly defined may be used as a reference signal.

The configuration information may be control information covering multiplexed time or frequency positions of the reference signals, a transmission period of the reference signals, antenna elements, and transmission sequences of the reference signals.

The invention is not limited to CSI-RS or CRS and can apply to other reference signals. For example, this invention may apply to reference signal for measurement, reference signal for mobility, or reference signal for beam management. The reference signal for measurement and reference signal for mobility may be referred to as measurement RS (MRS), mobility RS (MRS), respectively. The reference signal for beam management may be referred to as beam RS (BRS).

It may be transparent for the specification if reference signals are beam-formed. The beam selection (cell selection) includes not only beam selection but includes RS resource selection, cell-selection, port selection. The synchronization signal and/or reference signal may not be beam-formed.

The differences between respective cells and the number of supported reference signals or beams may be transparent for eNBs. For instance, if each of four cells transmits 10 reference signals or beams, the eNB may be notified transparently, such with a notification that indicates that 1 to 40 reference signals or beams are available.

One or more embodiments described above may apply to at least one of the idle mode and the connected mode.

One or more embodiments describe above may apply to at least one of cell connection, re-selection, handover, beam management, and CSI estimation.

While various embodiments of the present invention have been described above, it should be understood that they have been presented by way of example only and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

1. User equipment comprising:
a receiver circuit that receives at least one downlink reference signal transmitted from a cell;
a measurement circuit that measures quality of the downlink reference signal from the cell;
a controller configured to perform operations comprising:
determining whether sending a measurement report to the cell is necessary based on the measured quality of the downlink reference signal; and
generating the measurement report based on determining that sending the measurement report is necessary; and
a transmitter circuit that transmits the generated measurement report to the cell.

2. The user equipment according to claim 1, wherein
the receiver circuit receives reference signal groups including a plurality of downlink reference signals and signal group information, and
the measurement circuit measures the reception quality of the downlink reference signals for each of the reference signal groups,
the controller is configured to perform operations such that generating the measurement report comprises generating the measurement report based on the measurement results of the reception quality of the downlink reference signals for each of the reference signal groups configured from the cell, and
the transmitter circuit transmits the measurement report for each of the reference signal groups.

3. The user equipment of claim 1, wherein
the user equipment autonomously searches for at least one receivable downlink reference signals, and
the measurement circuit measures the received quality of the at least one downlink reference signal.

4. The user equipment of claim 1, wherein
the measurement circuit measures reception quality of at least one reference signal included in the downlink reference signals.

5. The user equipment of claim 2, wherein
the controller is configured to perform operations further comprising determining a necessity of a measurement report for each reference signal in the reference signal group.

6. The user equipment of claim 4, wherein
the transmitter circuit transmits a measurement report that includes a reference signal ID of the reference signal.

7. The user equipment of claim 4, wherein
the transmitter circuit transmits a measurement report that includes a reference signal group ID of the reference signal group.

8. The user equipment of claim 4, wherein
the transmitter circuit transmits a measurement report that includes a reference signal group ID and a reference signal ID of the downlink reference signals of the cell

9. The user equipment of claim 4, wherein
the transmitter circuit transmits a measurement report that includes a reception quality of the downlink reference signal from the cell.

10. The user equipment of claim 4, wherein
the receiver circuit receives a plurality of downlink reference signals transmitted from the cell, and
the transmitter circuit transmits a measurement report that includes a highest reception quality of the downlink reference signal from the cell.

11. The user equipment of claim 4, wherein
the transmitter circuits transmits a measurement report that includes a reference signal among each reference signal group measured by the measurement circuit.

12. The user equipment of claim 4, wherein
the transmitter circuit transmits a measurement report that includes the best-M value of received quality among each reference signal group measured by the measurement circuit.

13. A radio base station comprising:
antennas at least one dimensionally arranged;
a signal generator that generates a reference signal for channel measurement;
a configuration controller configured to perform operations comprising controlling the transmission of the reference signal in accordance with configurations using part or all of the antennas, the configurations including all or any of a horizontal relation, a vertical relation, and a cross-polarized relation;
a handover controller configured to perform operations comprising controlling a handover when a measurement report is received from a user equipment; a control signal generator that generates a control signal based on an instruction from the handover control unit; and
a transmitter circuit that transmits the reference signal in accordance with the configurations based on output from the configuration controller.

14. The radio base station of claim 13, wherein
the transmitter circuit transmits CSI-RSs, CRSS or SSs.

15. The radio base station of claim 13, wherein
the transmitter circuit transmits measurement RS, mobility RS or Beam RS.

16. The radio base station of claim 13, wherein
the signal generator generates a plurality of reference signals.
the configuration controller is configured to perform operations further comprising grouping at least one reference signal as reference signal group, and
the transmitter circuit transmits the reference signals for each of the reference signal group.

17. The radio base station of claim 16, wherein
the handover controller is configured to perform operations such that controlling the handover comprises controlling the handover based on the measurement report received from the user equipment that includes a reference signal ID of a downlink reference signal received from a cell by the user equipment.

18. The radio base station of claim 16, wherein
the handover controller is configured to perform operations such that controlling the handover comprises controlling the handover based on the measurement report received from the user equipment that includes a RS index of a downlink reference signal received from a cell by the user equipment.

19. The radio base station of claim 16, wherein
the handover controller is configured to perform operations such that controlling the handover comprises controlling the handover based on the measurement report received from the user equipment that includes a RS group ID and a RS index of one or more downlink reference signals received from a cell by the user equipment.

20. The radio base station of claim 16, wherein
the handover controller is configured to perform operations such that controlling the handover comprises controlling the handover based on the measurement report received from the user equipment that includes a reception quality of the reference signal received by the user equipment.
